(19) United States
(12) Patent Application Publication
(10) Pub. No.: US 2008/0069458 A1
(43) Pub. Date: Mar. 20, 2008

(54) DEPTH DETAIL LEVEL ADJUSTMENT OF MULTI-DIMENSIONAL IMAGE DATA WITH A CLIENT/SERVER-BASED IMAGE RENDERING SYSTEM

(76) Inventors: Fernando Vega-Higuera, Erlangen (DE); Klaus Engel, Donauworth (DE)

Correspondence Address: SCHIFF HARDIN, LLP;PATENT DEPARTMENT, 6600 SEARS TOWER, CHICAGO, IL, 60606-6473, US

(21) Appl. No.: 11/857,491

(22) Filed: Sep. 19, 2007

(30) Foreign Application Priority Data
Sep. 19, 2006 (DE) 10 2006 043 894.9

(51) Int. Cl. G06K 9/36

(52) U.S. Cl. 382/232

(57) ABSTRACT

In a client/server-based image archiving, image retrieval and image rendering system and method for storage, retrieval and graphical visualization of multi-dimensional digital image data such as assessment of medical image data, the detail depth level of volume data received via a data transfer network, to be shown in graphical form, is adjustable by the compressed volume data of subjects to be presented being stored with a highest-possible resolution (predetermined by an imaging system) in a databank administered by a server and directly accessibly only by this server. Although the client/server-based image archiving, image retrieval and image rendering system is able to offer volume data with this highest possible resolution to any point of the system at the request of a screen client, volume data are transferred to a screen client in a compressed form only up to a specific, spatially-variable, region-specific, or subject-specific detail depth level and are presented at the requesting screen client in graphical form. Complicated image rendering and image post-processing algorithms are implemented by the server.

### BACKGROUND OF THE INVENTION

1. Field of the Invention

The present invention concerns a client/server-based image archiving, image retrieval and image rendering system for storage, retrieval and graphical visualization of multi-dimensional digital image data that can, for example, be used in the clinical field in the framework of medical assessment of image data that show the inner organs, bone and muscle tissue of a patient to be examined. The invention in particular concerns a screen client and a method implemented by the screen client for adjustment of the depth detail level of volumetric image data (volume data) received over a data transfer network and to be presented in graphical form.

2. Description of the Prior Art

Presently available image archiving systems operating according to the “Picture Archiving and Communication System” (PACS) standard, standardized by ANSI, store digital image data of two-dimensional images either directly in a storage region of the respective imaging modality (for example by reconstruction of slice images from the raw data acquired by an image provider, for example a magnetic resonance or computed tomography apparatus), or in a storage region of a PACS workstation used for image post-processing and connected with the imaging modality via a data transfer network. As soon as the images are generated and stored in a central PACS databank, they can be retrieved via the workstation, presented on its screen in graphical form, and examined by a treating physician.

This system architecture of conventional image archiving and communication systems based on the PACS standard poses a number of problems which concern the clinical workflow.

Conventionally, only image data of reconstructed images are stored in a storage region of an imaging modality (for example reconstructed slice images of a three-dimensional abdominal computed tomography scan image with a slice image interval of 7 mm), and so only a fraction of the information reaches a physician working at the PACS workstation. For example, in the event that a further examination of the data shows that a new image reconstruction with a higher resolution is necessary for a precise diagnosis, the treating physician is forced to request a new image reconstruction, or to leave his or her workstation in order to move to the site of the imaging modality. In the event that he or she fails to interactively retrieve image data with a desired resolution via the PACS workstation, this leads to serious disruptions of the clinical workflow.

Image data from image series stored in a PACS databank have previously been transferred in full resolution to the PACS workstation regardless of the actual information requirement of a treating physician. Even when the displayable screen area is limited to a specific number of image points (pixels), for example to 420×420 pixels, all images of an image data set are conventionally transferred unchanged with a resolution of, for example, 512×512 pixels. This has a negative effect on the capacity of the underlying hospital-internal data transfer network when a critical number of users simultaneously access the PACS databank. In these situations a limit value is reached at which the capacity of the system collapses to a value which makes the use of the PACS system no longer practical. Moreover, it should be expected that this problem will limit the functionality of present PACS systems given image matrices of higher resolution (for example with 1024×1024 pixels).

PACS workstations presently do not have the same image post-processing functionality that the workstations (such as, for example, Siemens Leonardo workstations) equipped with special software programs for segmentation and 3D visualization of medical image data possess. In the event that the treating physician working at a PACS workstation requires a further post-processing of the image data (for example for refinement of the segmentation, for fine positioning of the 3D image reconstructions generated in a volume rendering technique (VRT) with regard to organs to be examined) during the assessment of individual CT or MRT data of a patient that are presented in graphical form on the screen of the PACS workstation, this leads to an interruption of the normal workflow. The treating physician is thereby forced to re-implement the post-processing steps with new parameter values, or to repair to the imaging modality in order to restart the imaging processes. The clinical workflow is thus interrupted by the limited post-processing possibilities of the PACS system.

As a result of the capability limitations of conventional PACS systems as described above, many computer-aided diagnostic (CAD) applications are presently not transparently integrated into the clinical workflow. The usage of image post-processing applications plays only a subordinate role for a number of physicians in the event that they are forced to interrupt their normal workflow.

Present PACS systems are based on the storage of reconstructed slice images in a central databank after a patient examination was conducted at the site of an imaging modality. With the aid of the imaging modality, a technically versed expert thereby generates a series of slice images from a plurality of scanned raw data using a predetermined slice image interval and a predetermined resolution. These reconstructed images are then transmitted to a server that stores them in a central databank. PACS workstations and other workstations suitably configured for image post-processing then execute a query to the server which then delivers the data of the individual slice images via a data transfer network according to the DICOM standard.

The scanned raw data typically are not stored in the databank. Nevertheless, if this should be the case, the data are immediately deleted after conclusion of the diagnosis in order to keep the storage space requirement low. The generation of slice images with different resolutions is not possible in PACS workstations. A further problem is the absence of computer-aided diagnostic tools in many PACS workstations. In order to solve this problem, some client/server-based software programs have been brought onto the market.

For example, TeraRecon Inc. offers the AquariusNET™ server as a solution based on the VolumePro ray tracing hardware. The system architecture is based on a 3D image data server that is appropriate for the generation of image data of full resolution and for a data stream transfer of the generated image data to a number of screen clients. The screen clients serve only as image display devices that communicate image generation queries to the server. In the event that the number of the clients increases, however, the image generation rate drops steeply since the server must distribute the image generation resources to the respective clients. Moreover, very large data sets occur given the data stream transfer of generated image data in real time. For example, given an RGB-encoded image generated for a screen area with 1280×1024 pixels, more than 110 MByte of data accrue in only one second given a data transfer rate of 30 frames/s. No conventional PACS system offers the possibility of a depth detail level (LOD)-based navigation and visualization.

Geographical information systems (GIS) present a similar problem relative to the present visualization systems for graphical presentation of medical image data. In both cases immense sets of vector data (for example with regard to the position, size, temperature and land coverage of geographical objects, etc.) must be interactively visualized and manipulated. Many of the web-based GIS software solutions (such as, for example, Map24 or Google Earth) that are commercially available solve this problem by displaying image data according to the current requirements of a user using various depth detail levels. In the present invention the same idea is utilized for design of a PACS system that is suitable for transparent graphical visualization of medical image data present in full resolution. In order to accomplish this, a client-specific graphic hardware for acquisition and graphical visualization of multi-dimensional digital image data is used by the PACS clients, and an efficient data compression scheme is introduced for storage on the server of volume data in full resolution.

The compression and data stream transfer of image data of two-dimensional images based on the JPEG2000 format is well known among image processing experts (see, for example, Thomos, N., Boulgouris, N. V. and Strintzis, M. G.: “Wireless Transmission of Images Using JPEG 2000” in: Proceedings of IEEE International Conference on Image Processing, ICIP 2004, Singapore, p. 2523-2526, October 2004). Moreover, the commercially available software tools for compression of medical volume data (such as, for example, Aware JPEG2000-3D from the company Aware Inc.) are based on the JPEG2000 format. This technology was already developed by the research department of the company Siemens (see, for example, Siegel E., Siddiqui, K. et al., “Compression of Multislice CT: 2D vs. 3D JPEG2000 and Effects of Slice Thickness” in: Proc. SPIE, Volume 5748, p. 162-170, Medical Imaging 2005: PACS and Imaging Informatics). Finally, the visualization of very large sets of volume data in the field of data compression with a client-specific graphic hardware is a current theme among experts in computer graphics (see, for example, Guthe, S. and Straβer, W., “Real-Time Decompression and Visualization of Animated Volume Data” in: Proceedings of the Conference on Visualization '01 (San Diego, Calif., 21st-26th Oct. 2001), IEEE Computer Society, Washington D.C., p. 349-356 as well as Schneider, J. and Westermann, R., “Compression Domain Volume Rendering” in: Proceedings IEEE Visualization 2003).

U.S. Pat. No. 6,683,933 discloses a client/server-based image retrieval and image rendering system with a screen client connected to a data transfer network. The screen client has suitable means for gathering and evaluation of voxel-based 3D image data of objects (volume data) to be presented (which voxel-based 3D image data are received from a network server); means for post-processing of these 3D image data with regard to the spatial coordinates and orientation angles, the surface color and opacity of shown objects; and means for image preparation and three-dimensional graphical visualization of the objects to be shown via projective mapping of these post-processed volume data onto the two-dimensional image plane of the client screen. The parameter values of the projective mapping this can be individually predetermined by a user via a user interface of the screen client.

United States Patent Application Publication No. 2004/0179744 describes a data transfer method in a data transfer system based on the client/server principle, wherein data that should be transferred from a server to a client terminal before the data transfer from the server are converted by redundancy reduction into a hierarchical data representation, such that these image data can be reconstructed on the client terminal with a desired low resolution (dependent on the compression rate achieved by the redundancy reduction) and presented in graphical rendered form. For reconstruction of a new, high resolution presentation, the client terminal requests from the server additional data that are then provided by the server and sent to the appertaining client terminal via a data transfer line of a computer network. The image data exist in a hierarchical data representation in the form of a “pyramidal data structure” that includes multiple hierarchy levels. In which data structure, non-redundant data (“incremental transform data”) in a storage region of the server are associated with each of these hierarchy levels, with which non-redundant data compressed 2D or 3D image data of a specific minimum resolution can be expanded (for example by wavelet decomposition) per image region into image data of a higher depth detail level (multi-scale presentation) depending on the desired hierarchy level to be predetermined by a user. This occurs after suitable wavelet coefficients have been requested from the server and downloaded into a storage region of the client terminal.

Conventional techniques for visualization of two-dimensional image data in multiple depth detail levels (“multi-resolution visualization”, MRV) that are used in, for example, video-on-demand-based or Internet-based image server applications, are discussed and compared in the lecture documents of the course “An Introduction to Information Visualization Techniques for Exploring Large Databases” taught at the University of North Carolina in Charlotte by Dr. Jing Yang in the fall of 2005, which documents are accessible at the URL http://vadl.cc.gatech.edu/documents/34_Yang_class5_multireex.pdf. For example, the generation of multi-scale presentations using wavelet decompositions, volume rendering techniques for reconstruction by means of 3D texture mapping of 3D views of different resolutions of image regions to be presented, and the possibility of an image data compression by selectively refinable progressive meshes (“multi-resolution meshes”) for presentation of image regions at a predefinable depth detail level, are discussed.

The article “Radiology on handheld Devices: Image Display, Manipulation and PACS Integration Issues” (in: RadioGraphics (RG), Vol. 24, No. 1, pp. 299-310, © RSNSA 2004) by B. Raman et al. concerns the use of personal digital assistants (PDAs) that can be operated with one hand in the field of tele-radiology, as well as DICOM-conforming medical technology image archiving, image retrieval and image rendering system operating according to the client/server principle according to the PACS standard. In the system described therein, a PDA server acts as a gateway between an image databank and a number of client PDAs connected to the system, and requested image data are transferred to the individual clients at a specific color depth and a specific depth detail level that are predetermined by the employed display technology or the screen or display resolution (i.e. by the pixel count per screen or display surface) of the respective client PDAs.

### SUMMARY OF THE INVENTION

Starting from the aforementioned prior art, an object of the present invention is to simplify the workflow to achieve a reduction of the data traffic (for the purpose of reducing the degree of system utilization) between an image data server and client terminals of an image archiving, image retrieval and image rendering system with regard to the requesting and transfer of compressed image data required for an image rendering. The image archiving, image retrieval and image rendering system is based on the client/server principle, the image data being necessary to present image regions of different depth detail levels on a screen client.

The above object is achieved in accordance with the invention by a screen client of a client/server-based image archiving, image retrieval and image rendering system for gathering, storage, retrieval and graphical visualization of multi-dimensional digital image data, as well as a method implemented from this screen client, for adjustment of the depth detail level of digital image data to be presented. The method can, for example, be used in the context of medical assessment of image data to be graphically presented, the image data showing the internal structure of organs of a patient to be examined.

The basis of the invention is to store, for each patient examination, a single set of volume data in full resolution in a PACS databank. The gathering and evaluation of the volume data is enabled by a client/server arrangement in which information are displayed only up to a depth detail level (LOD) that is predetermined by the current requirements of a physician working at the PACS workstation, regardless of the quantity of volume data. This is achieved by a proportionate data stream compression and storage of the volume data by the server with subsequent data transfer to the individual clients, with a step-by-step reconstruction and display of the volume data ensuing supported by the client-specific graphic hardware. The data with the highest possible resolution thus are always available to the physicians at all client connected to the PACS server. Moreover, an unnecessary, redundant storage and transfer of the data is avoided. Image post-processing functionalities are offered at the PACS clients, using a similar client/server approach. This represents a shift away from the conventional slice image-oriented PACS system toward a volume data-oriented PACS system architecture.

The compressed volume data of subjects to be presented that are required for an image rendering are stored with a highest-possible resolution (predetermined by an imaging system) in a databank administered by the server and are only directly accessible by the server. Complex filtering, segmentation, clustering, rendering, feature extraction and/or pattern recognition algorithms to be conducted on the volume data are inventively executed by the server while less complicated image processing or image post-processing algorithms are inventively executed on these volume data by the screen client.

According to the invention, an image retrieval and image rendering method that include the following steps is implemented by the screen client. After a partitioning of a virtual subject space (which virtual subject space is to be presented in graphical form) into volume units of a predetermined shape and size. Compressed volume data of subjects arranged within this virtual subject space (which subjects are to be graphically presented) are loaded from a server with a depth detail level that is predetermined by the size of these volume units; and the decompression of these volume data. According to the invention a display of the virtual subject space as well as of the subjects located therein is initially presented at the depth detail level predetermined by the size of the volume units. Thereafter, the volume units of the virtual subject space that are occupied by the appertaining subjects are successively partitioned into respective small sub-units up to a specific partition (division) depth dependent on the distance of the respective subjects from the observation point in front of the screen plane of the screen client. The fineness of this partitioning inventively increases in the direction of the observation point and decreases in the opposite direction; and compressed volume data of the subjects are automatically, successively downloaded from the server and decompressed step-by-step with a depth detail level predetermined by the size of the sub-units. The display of shown subjects is then refined step-by-step by generation of a higher-resolution representation of these subjects with a depth detail level that is predetermined by the size of the respective sub-units.

In the aforementioned partitioning, the virtual subject space is partitioned into volume units of the predetermined shape and size using a tree-like hierarchical data structure, which allows only those volume data to be retrieved that correspond to image regions that are simultaneously used by a user working at the screen client.

According to the present invention, the server can operate, for example, a compression scheme for compression of the volume data requested by the screen client, this compression scheme encoding the regularity of shapes, surface textures or, respectively, subject structures of subjects to be presented. This compression scheme can be, for example, a wavelet compression of volume data requested by the screen client. These volume data are data for an image rendering of two-dimensional or three-dimensional raster graphics that can be time-independent or time-dependent. According to the invention, function values of the spatially-variable, region-specific, or subject-specific depth detail level of displayed subjects are stored for the volume data of every rendered image.

Moreover, the present invention concerns a server of a client/server-based image archiving, image retrieval and image rendering system that has a unit for local caching of compressed volume data with a highest possible resolution (predetermined for this system) from a databank administered by the server and that is only directly accessible by this server; as well as a unit that converts the volume data into a lower-resolution data format with a spatially-variable depth detail level dependent on the perspective depth distance of subjects to be presented from a defined observation point in front of the screen plane of a screen client, a unit that compresses and provides the volume data converted into this data format.

The invention also concerns a screen client connected via a data transfer network to a server of a client/server-based image archiving, image retrieval and image rendering system, wherein said screen client has, among other things, a unit that partitions a virtual subject space (to be presented in graphical form) into volume units of a predetermined shape and that successively partitions the volume units into smaller sub-units up to a maximum achievable partition depth. The fineness of this partitioning increases in the direction of an observer and decreases in the opposite direction. Moreover, this screen client includes a unit that loads from a server, compressed volume data of subjects arranged inside this virtual subject space (which subjects are to be graphically presented) with a depth detail level predetermined by the size of the volume units, as well as for successive, automatic downloading from the server of higher-resolution, compressed volume data of the subjects with a depth detail level predetermined by the size of the sub-units, and a unit that decompresses the volume data. At the screen client, a presentation unit shows a display of the virtual subject space and the subjects located therein in the depth detail level predetermined by the size of the volume units, and undertakes step-by-step refining of the view of presented subjects by generation of a higher-resolution presentation of these subjects with a depth detail level predetermined by the size of the respective sub-units.

The present invention also concerns a client/server-based image archiving, image retrieval and image rendering system for storage, retrieval and graphical visualization of multi-dimensional compressed image data, wherein compressed volume data of subjects are presented, and wherein volume data are requested from a server via a screen client and are required for an image rendering, can be transferred to the screen client only up to a specific, spatially variable, region-specific, or subject-specific depth detail level, and can be presented on the screen client in graphical form.

The spatially variant, region-specific or subject-specific depth detail level of subjects to be presented can in turn depend on, for example, the perspective depth distance of these subjects from a defined observation point in front of the screen plane of the screen client.

The compressed volume data of subjects to be presented that are required for an image rendering are stored in a databank with a highest-possible resolution that is predetermined for this system, the databank being administered by the server and being directly accessed only by said server.

The present invention also concerns a computer software program product for implementation of the illustrated image retrieval and image rendering method given operation on a screen client of the client/server-based image archiving, image retrieval and image rendering system as described above.

### BRIEF DESCRIPTION OF THE DRAWINGS

FIG. 1A is a block diagram of the system architecture of the inventive client/server-based image archiving, image retrieval and image rendering system.

FIG. 1B is a block diagram of the system components at the server or at a screen client in a system according to the invention.

FIG. 2 shows the user interface of a web-based geographical information system (Google Maps) with three views of different representation scales of a geographical scale map for true-to-scale cartographic representation of geographical regions in different depth detail levels dependent on the presentation scale.

FIG. 3 is a magnetic resonance image for two-dimensional presentation of partitioned volume data of a longitudinal section through the bone and muscle tissue in the region of the abdomen, the pelvis and the lower extremities of a patient to be examined, with a quadratic grid mesh (represented dash-dot) for illustration of the partitioning of the shown image region into a eight sub-units.

FIG. 4 shows a magnetic resonance exposure in seven different size formats and seven different presentation scales for two-dimensional presentation of the volume data of the bone and muscle tissue designated in the preceding in seven different depth detail levels (“MIP mapping” scheme).

FIG. 5 shows three views of satellite exposures of a portion of the Earth's surface for realistic representation of geographical regions in different presentation scales and depth detail levels, retrieved from a web-based geographical information system (Google Earth).

FIG. 6 illustrates the partitioning and automatic depth detail level adjustment of volume data to be presented using an eight unit tree structure for successive partitioning of a subject space into cubical volume units in which subjects near to an observer are presented in a higher depth detail level than spatially remote subjects, in accordance with the invention.

### DESCRIPTION OF THE PREFERRED EMBODIMENTS

The system components of the inventive client/server-based image archiving, image retrieval and image rendering system and the steps of the associated inventive method are described below. Without limitation as to generality, the discussion is based on a server and a number of screen clients (also designated as client workstations) that communicate with one another via a data transfer network via a communication standard PACS. The present invention, however, is applicable not only to such a PACS system but also is generally applicable to client/server-based image archiving, image retrieval and image rendering systems and thus independent of the communication standard underlying the data transfer.

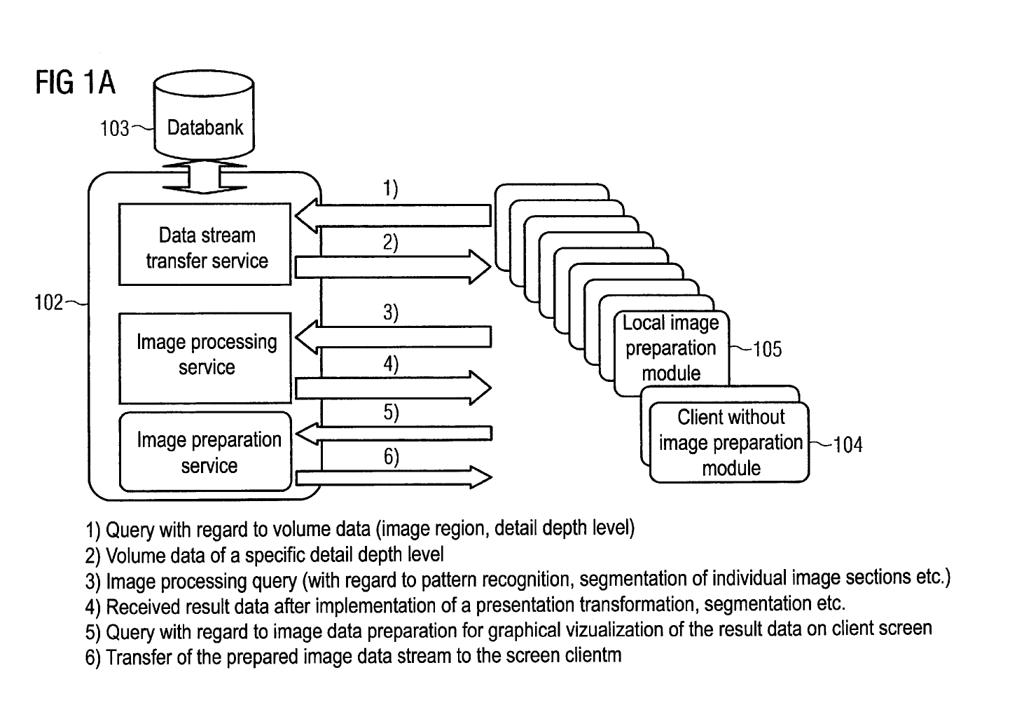

As shown in FIG. 1A, the inventive image archiving, image retrieval and image rendering system is constructed around a client/server architecture in which only one server 102 (which is responsible for the transfer of volume data to a plurality of screen clients 104) and its data storage 103 have direct access to volume data of full resolution. The server 102 is responsible for the processing of queries executed on the part of the clients 104 with regard to the adjustment of depth detail levels for specific image regions of generated volume data. After processing such a query, the appertaining volume data are transferred as a data stream to the clients 104. The clients 104 reading the data implement a step-by-step deconstruction of the volume data and present the data, for example, in the form of two-dimensional images or in 3D image reconstructions generated in a volume rendering technique. If the clients 104 have no image preparation functionality (as shown in FIG. 1A), the server 102 provides an image preparation service that enables a remote visualization after the occurrence of a data stream transfer of generated volume data to the clients 104. Complex image post-processing algorithms such as, for example, filtering, segmentation or pattern recognition algorithms are executed by the server 102, while less complicated tasks are handled by the clients 104. Supported by a client-specific graphic hardware in the form of local image preparation modules 105, the clients 104 thereby implement an image preparation method.

A more detailed block diagram of the system components by a server 102 or by a screen client 104 for realization of the inventive image archiving, image retrieval and image rendering system is shown in FIG. 1B. As can be seen in FIG. 1B, volume data that are required for refining of the raster image presentation of a number of subjects 604 shown in a medium depth detail level on a screen 106 of the screen client 104 are stored with a highest possible resolution (predetermined for this system) in an external image archive 103 (which image archive 103 can be accessed only by the server 102). The depth detail level of presented raster images is predetermined by a partitioning unit 104c of the screen client 104, with which a virtual subject space to be presented is partitioned into volume units of a specific shape and size. Upon receipt of a query (the query being executed automatically or, for example, in the course of an image section enlargement operation by a user) of the screen client 104 to increase the resolution of segmented image regions, the highest-possible resolution volume data are loaded via an input/output interface 102a into a local cache 102b of the server 102. A suitable control command of the central processing unit 102c (CPU) to the server 102 is supplied via a bus system. Dependent on the distance of the respective subjects 604 from a defined observation point 601 in front of the screen plane of the screen client 104, the server-internal central processing unit 102c inventively converts the volume data of the presented subjects 604 and the volume data received from the external image archive 103 into volume data of a higher depth detail level, and relays the resulting data of this process to a compression module 102d where it is subjected to a JPEG or MPEG compression, depending on whether the volume data is still image or moving image data. The compressed volume data are then directed via the bus system to the input/output interface 102a of the server 102, transferred via a data transfer network (not shown) to an input/output interface 104a of the screen client 104, and successively loaded from a storage means 104b of the aforementioned screen client 104. The successively loaded volume data are intermittently decompressed by a decompression module 104d, whereupon the virtual subject space to be presented is successively partitioned into volume units 602c of a specific shape and size up to a specific spatially-dependent partition depth with the aid of the partitioning means 104c, dependent on the spatially-dependent depth detail level of the intermittently decompressed volume data. The fineness of this partitioning increases in the direction of the observation point 601 and decreases in the opposite direction. Meanwhile, the decompressed volume data are supplied to a local image preparation module 105 (which module 105 is present on the part of the screen client 104 in a first exemplary embodiment of the present invention) where the data are converted into three-dimensional or four-dimensional (with a time-dependency image data) by projective mapping. The data are converted into a perspective presentation form suitable for two-dimensional presentation on a screen before they are displayed on the screen 106 of the screen client 104 with the spatially dependent depth detail level predetermined by the loaded volume data. If the computation capacity of the screen client 104 is not sufficient to locally execute the complicated image rendering and image post-processing processes required for this purpose, these processes are likewise implemented by the central processing unit 102c of the server 102, according to a second exemplary embodiment of the present invention.

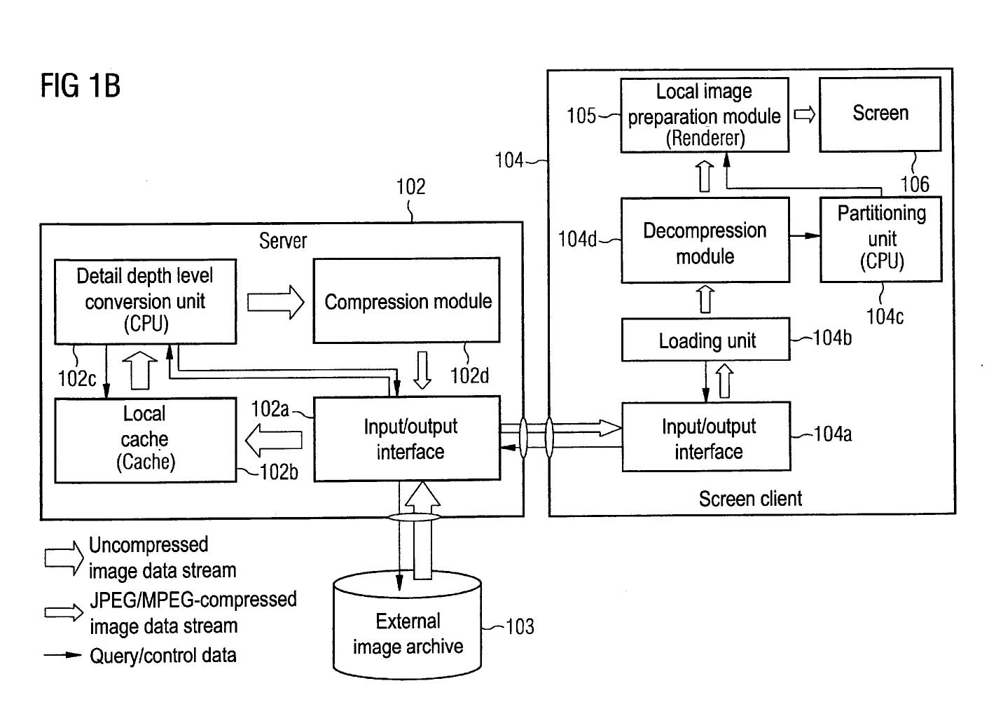

The server 102 shown in FIG. 1B is, for example, capable of providing patient data to a plurality of screen clients 104, which patient data exist in a number of different resolution levels depending on the depth detail level currently required by the users on the side of the clients 104. A web-based geographical information system such as, for example, Google Maps or Google Earth can provide this scheme just as well, by high-resolution geographical data being stored on a central server and being rendered in the form of various views of different presentation scales as geographical scale maps (I, II and III) for true-to-scale cartographic representation of geographical regions in different depth detail levels depending on the presentation scale (see FIG. 2). As can be seen from FIG. 2, the depth detail level increases with increasing presentation scale of the geographical regions mapped on these scale maps I, II and III.

The clients 104 can be connected with the server 102 and executed individual data queries with regard to specific image regions and resolution levels. The inventive image retrieval system is based on this concept, but uses tomographical data instead of geographical data as a three-dimensional “map” of the human body. In order to handle queries from a number of clients 104 and to be able to keep the data traffic over the data transfer network within the normal operating range of clinical institutions, an efficient data compression method must be implemented on the part of the server 102.

A further aspect to be considered in the establishment of the services provided by the server 102 is the availability of computer-aided diagnosis tools on the part of the PACS client 104. Algorithms that are used in the framework of the computer-aided diagnosis are often very complex and connected with high computation effort. In order to keep the capacity of the image retrieval system at a high level and to simultaneously keep the requirements of the clients 104 (which requirements concern the necessary hardware configuration) within an affordable measure, the server 102 inventively provides image processing services for filtering, segmentation, clustering, rendering, feature extraction, pattern recognition and/or other complex image processing algorithms.

Patient data can be generated using two fundamental processes by generation of scan images on the part of the imaging modalities or by image post-processing on the part of the respective workstations. In the first case, the patient data correspond to image series which belong to one or more four-dimensional scalar fields φₙ(\vec{x}ₑ(t)) with the function rule \vec{x}ₑ:\vec{x}ₑ(t) [symbol] φₙ(\vec{x}ₑ(t))∀n (with \vec{x}ₑ(t):=[x,y,z,t]^{t} ε [symbol] ⁴ for t≧0,φₙ(\vec{x}ₑ(t))ε [symbol] ∀n and nε [symbol] ), whereby n designates the index number of the respective scalar field and the parameter vector \vec{x}ₑ(t) designates a three-dimensional spatial vector \vec{x}:=[x,y,z]^{T}≡\vec{OP} ε [symbol] ³ expanded by the time coordinate t in a Cartesian object coordinate system with the coordinate origin O, which reflects the dependency of the three Cartesian spatial coordinates x, y and z of a subject point P(x, y, z) to be presented on the time t. Image data of two-dimensional slice images as well as volume data acquired by a radiological imaging method are considered as special cases of animated 3D raster graphics (also designated in the following as 4D image data sets or time-varying 3D image data sets). Image data obtained by image post-processing can also be generated as scalar fields or as data of a special data type, for example via implementation of a segmentation, a presentation transformation or region marking of imaged subjects. In the inventive client/server-based image archiving, image retrieval and image rendering system these special data types are generally stored and transmitted using typical compression schemes (zip, gzip, bzip2 etc.). By contrast, volume data are stored using a special compression scheme that utilizes the regularity of shapes, surface textures or subject structures of subjects to be presented and allows a step-by-step transfer of compressed image data in the form of a data stream.

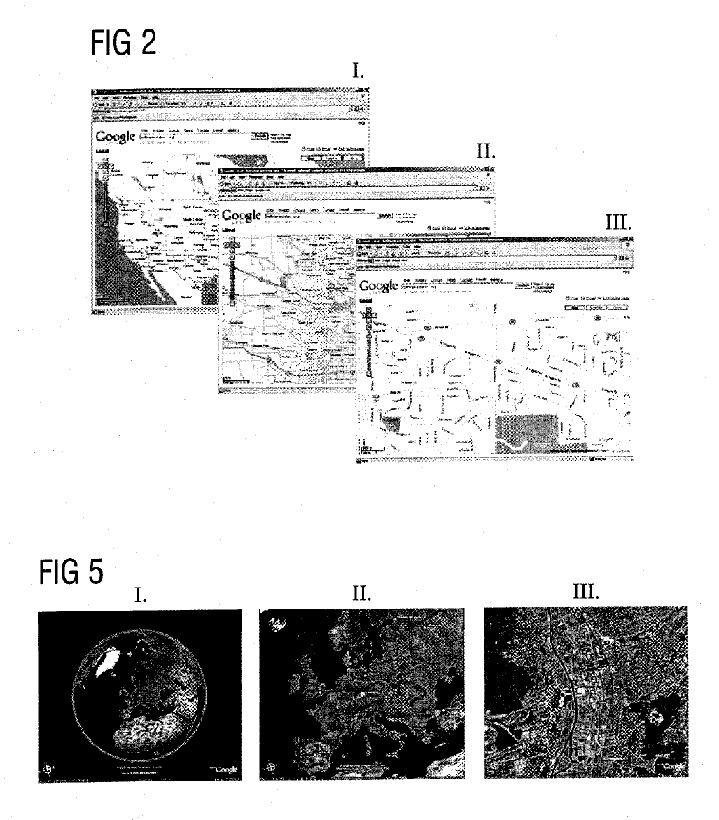

The inventive method for compression of volume data is a three-dimensional expansion of the JPEG2000 file format which is used for storage of image data of two-dimensional images. Since successive slice images of a data set composed of common volume data are very similar to one another, the compression rates for the volume data set acquired with a radiological imaging method are very high. According to this compression method, a single data set with the largest resolution available at the reconstruction point in time is stored on the server per patient examination. The volume data of a subject space are additionally partitioned using an eight-level tree structure, which allows only those data to be retrieved that correspond to image regions which are directly used by the user working at one of the clients 104. An eight-level tree structure is a hierarchical data structure that describes a subject space 602 by successive partitioning into cubical volume units 602c that comprise eight respective partial cubes 602a/b of half the edge length (which partial cubes 602a/b abut one another in pairs over their side surfaces) up to a predetermined partitioning depth (for example up to individual voxels). This hierarchical data structure is thus suitable to represent real or virtual subjects 602 by cubical space partitioning with a specific depth detail level, thus with a predetermined differentiation. An example for the partitioning of a subject space to be presented (which partitioning is inventively effected using such an eight-level tree structure) into a number of volume regions to be stored with different depth detail levels dependent on the distance of these volume regions from an observer is illustrated by the quadratic grid mesh of the magnetic resonance exposure depicted in FIG. 3, which shows a longitudinal section through the bone and muscle tissue in the region of the abdomen, the pelvis and the lower extremities of a patient 604 to be examined. In this example it is assumed that the volume units 602a with the lowest distance from the observer are located in the upper left corner of the shown image section and that the volume units 602c with the greatest distance from the observer are located in the right lower corner of the shown image section. As a consequence, the volume units are partitioned successively finer in the direction of the left upper corner of the shown image section and the associated image regions of these volume units are stored with a resolution that increases in the direction of the left upper corner, which is indicated by the edge lengths (which edge lengths are smaller by a factor of two or, respectively, by a factor of four) of the volume units 602b or 602a obtained by successively finer partitioning in the left upper corner in comparison to the volume units 602c of the remaining image section (which volume units 602 advantageous embodiment not more finely partitioned).

In order to keep the image construction time by the screen client 104 as short as possible, volume data that belong to different depth detail level are transferred to the individual clients 104 as a data stream until a resolution desired for the image generation is reached. This can be achieved, for example, by the use of stored wavelet transformations operating on the volume data obtained in the JPEG2000 files. Volume data from images of medium resolution, i.e. volume data of images with a depth detail level provided by an imaging modality, are displayed without further delay on the screens of the clients 104 similar to as in texture MIP mapping. A 3D effect for realistic, versatile presentation of the surfaces of near and remote objects by the use of textures of different resolution is achieved with which interfering step effects and smearing of closer objects due to too-large textures are avoided and perspective depth effects are achieved by a reduction of the depth detail level of textures of remote objects. A step-by-step refining of the depth detail level is effected as soon as additional information required for this is delivered by the server 102 in the form of a data stream.

The server 102 provides a remote image generation service (designated in FIG. 1A as an “image preparation service”) for clients 104 that do not satisfy the requirements for a detection, evaluation and processing of a data stream composed of two-dimensional, three-dimensional or (with additional consideration of a time dependency) four-dimensional image data with a computer operating unit 105 available at their location. The server 102 is capable of implementing a graphical visualization of volume data with different depth detail levels according to queries executed by the clients 104. Image data generated by the server 102 are then transferred to the clients 104 in the form of a data stream using video compression schemes.

Computer-aided diagnosis tasks that require data processing capacities beyond the capabilities of average user hardware are inventively executed on the part of the server 102 in order to keep the total computing power of the system installed at the sites of the clients 104 at a constant level. Tasks classified as “server-supported” are converted by the clients 104 into query data packets that are transmitted to the server 102. The server 102 then implements the appertaining algorithm (for example filtering, segmentation or pattern recognition algorithm etc.) on the data and then delivers the results of this processing back to the appertaining client 104. A load distribution method with priorities that are assigned depending on the complexity of a task to be accomplished is applied in which tasks that are simple to execute are handled by the computer operation unit (designated as “local image preparation modules” in FIG. 1A) by the clients. In this allocation of the computer operation unit, the processing time durations by the clients 104 are safely kept within a time window which is required for integration of computer-aided diagnosis tools in the clinical workflow.

In the inventive client/server-based image archiving, image retrieval and image rendering system, the PACS workstations 104 are designed to provide a fast acquisition and evaluation of a data stream composed of two-dimensional, three-dimensional or four-dimensional image data, as well as to provide computer-aided diagnosis tools running on user PCs. This is achieved by a process running on one of these screen clients 104 and responsible for an image post-processing, in that complex tasks are delegated to the server 102 while simpler tasks are handled on site, i.e. by the appertaining client itself. With the process running on one of the screen clients 104 and responsible for the acquisition and evaluation of received image data, image data of two-dimensional images with different depth detail levels are generated according to a concept which employs the storage scheme explained above. 3D image reconstructions generated in a volume rendering technique with three-dimensional and four-dimensional image data require a special texture-based image preparation module for volume data in connection with a user graphic hardware. If the client hardware provides no functionalities for image generation, assuming a data stream composed of two-dimensional, three-dimensional or four-dimensional image data, the inventive image retrieval system automatically switches over to a remote image generation mode and displays the image data arriving from the server 102 in graphical form on a client screen. In this scheme the appertaining client 104 is disburdened of the generation of three-dimensional image reconstructions from image data of two-dimensional slice images since it can access a data set of volume data in which the numbers of individual slice images or their respective resolutions are without importance. The user thereby perceives image data of an image as an image with “unlimited resolution”, so he/she can navigate transparently regardless of the respective data set.

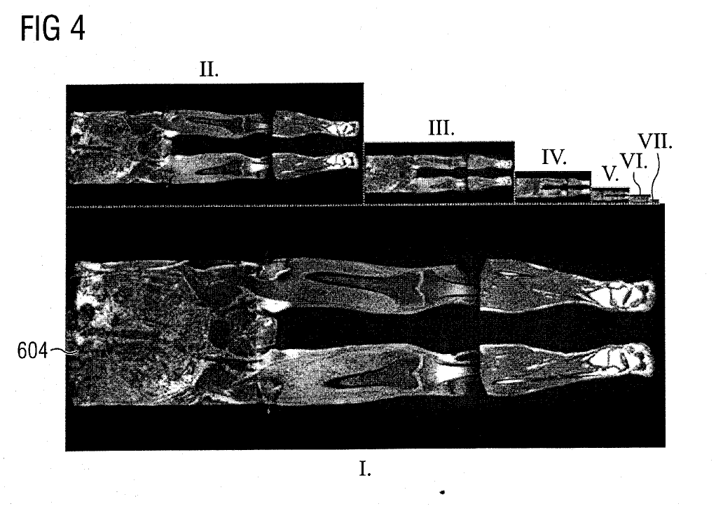

Similar to a digital map service (such as, for example, Map24, ViaMichelin, Google Earth etc.) in which, for example, various views of satellite exposures (I, II and III) of a portion of the Earth's surface are rendered in different presentation scales and depth detail levels for realistic representation of geographical regions (see FIG. 5), the client 104 initially requests image data with a relatively rough (coarse) depth detail level from the server 102 in order to enable the user to orient herself or himself. As soon as the user has recognized an image region in which the user is interested, the user implements an image section enlargement (zooming) or image cropping operation (cropping) at the desired image section. The client 104 then executes a query to the server 102 concerning the predetermined image section and the greatest possible depth detail level that can be presented in the respective screen layout. The portion of the image data retrieved from the server 102 corresponds to segments of an eight-level tree which concerns the image region of interest plus a boundary region around the region of interest in order to enable navigation both in the image plane and orthogonal to this plane. In the event that the user navigates outside of the initially retrieved image region, a new query is executed and image data of an updated image region are loaded into the client 104. The newest data queries are locally cached in local storage devices at the client 104 in order to enable a fast retrieval of image regions that are contiguously examined by the user.

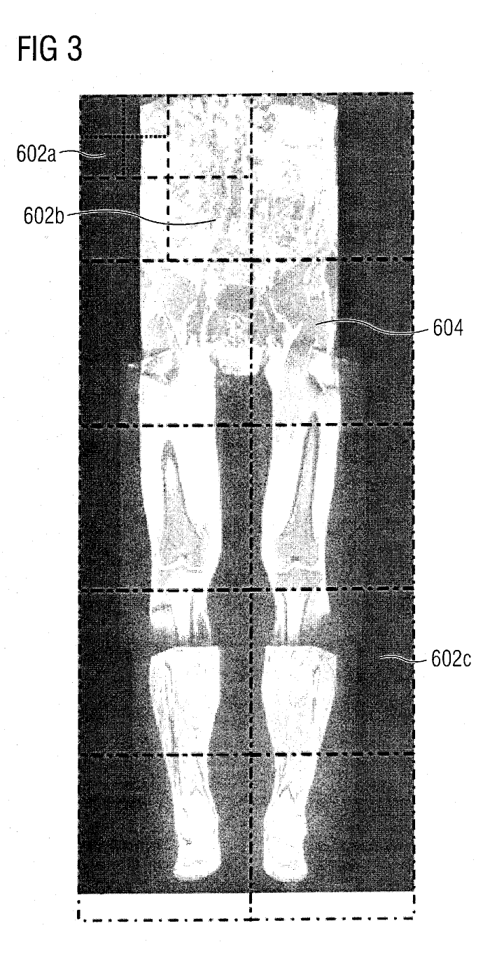

A texture-based image preparation module 105 for volume data is based on a user hardware, and is used for acquisition and evaluation of a data stream comprising three-dimensional or (given additional consideration of a time dependency) four-dimensional image data in the inventive client/server-based image archiving, image retrieval and image rendering system. This is an extension of the graphic processor-supported image preparation module used in the VRT system Syngo 3D from the company Siemens. In order to obtain a high image construction rate regardless of the depth detail level used, the subject volume 604 to be examined is partitioned into partial volumes using an eight-level tree structure that is analogous to the eight-level tree structure that is used for storage of the volume data on the server 102. If the entire subject volume is shown on the client screen at an observation point in time t₀, a raster image is used for all partial volumes that has a relatively rough depth detail level that composed of a series of raster images of different resolution that all show the same subject 604 (“MIP map”). An example for such an “MIP mapping” scheme is presented in FIG. 4, which shows a magnetic resonance exposure in seven different size formats and seven different presentation scales (I through VII) for three-dimensional presentation of the volume data of the bone and muscle tissue in the region of the abdomen, the pelvis and the lower extremities of a patient 604 to be examined in seven different depth detail levels (“MIP levels”). As can be seen from FIG. 4, the depth detail level increases with increasing presentation scale of the body regions depicted in this magnetic resonance image and with increasing size format of the magnetic resonance image. In order to be able to present this magnetic resonance image in a predeterminable size format in a predeterminable presentation scale, image data of different depth detail levels, which are stored on a server as partitioned volume units of different size in the form of an eight-level tree structure, are loaded onto a screen client and graphically visualized there in 2D-rendered form dependent on the distance of the respective volume regions to be shown from an observer. Image regions of volume units closer to the observer are presented in a greater depth detail level than image regions of volume units further from an observer. If the user implements an image section enlargement operation at a specific image region, the corresponding parts of the image data are retrieved from the server 102 and only those partial volumes that fall inside the updated camera perspective region are subjected to an updating. Raster images of different depth detail levels depending on the distance between subject and camera are subsequently used.

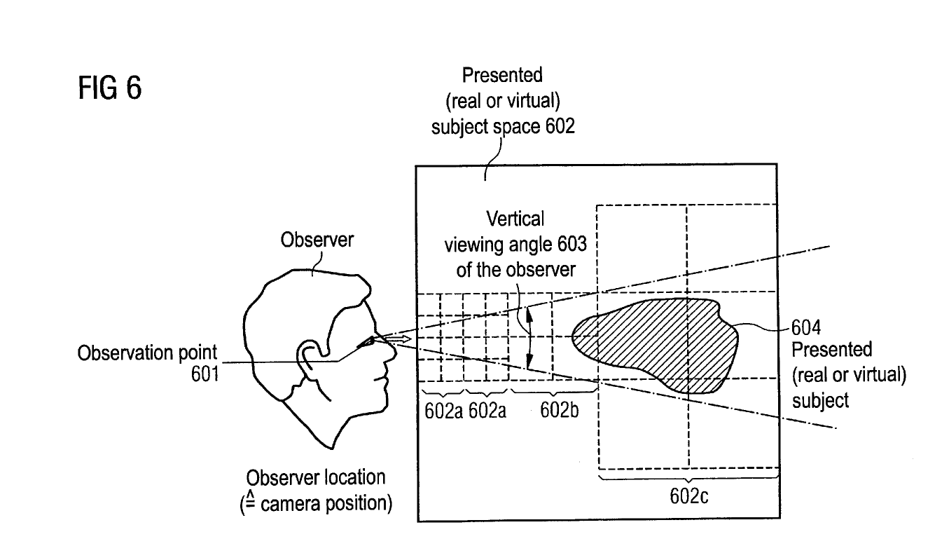

This principle is illustrated in FIG. 6, which shows the solution approach employed in the present invention for partitioning and automatic depth detail level adjustment of volume data to be presented with an eight-level tree structure for successive partitioning of a presented real or virtual subject space 602 into cubical volume units 602c up to a predetermined partitioning depth. The tree is composed of eight partial cubes 602a/b of half of the edge length that abut one another in pairs at their side surfaces. As can be seen from FIG. 6, an automatic adjustment of the depth detail level is effected dependent on the distance between the camera position and the location of a real or virtual subject 604 to be presented. By this adjustment, subjects that are spatially proximal with regard to the location of an observer 601 (i.e. with regard to the camera position) are presented in a higher depth detail level than subjects that are spatially remote relative to the observer standpoint. For this reason, the partitioning of the presented subject space 602 into cubical volume units 602a-c, and therewith the differentiation of the presentation of the shown real or virtual subject 604 in the direction of the observer 601 (at least within the observer's viewing angle 603, i.e. within the subject scenario that can be recorded by the camera), becomes ever finer. Moreover, in the inventive image retrieval system a program for gathering and visualization of two-dimensional and three-dimensional, time-dependent image data requested and rendered by the server 102 is implemented by the screen client 104.

Depending on the limits of the capability of their computer hardware and software installed on site, screen clients generally provide image post-processing functionalities only in a limited scope. According to the invention, only simpler tasks that can be handled with the graphic processor available on site (i.e. at the installation location of the respective client 104), or the central processing unit of the client within reasonable time frames (such as, for example, a simple filter operation), are implemented on site. Complex tasks (such as, for example, the implementation of pattern recognition or complex segmentation algorithms) are delegated to the server 102 in the form of image processing queries. As soon as the server 102 has executed the requested task, it transfers the received result data to the appertaining client 104 as a data stream which the client 104 displays on site.

In addition to the assessment and reporting functionalities of present PACS systems, the inventive client/server-based image archiving, image retrieval and image rendering system has the capability of storing VRT parameters that ensure a reproducibility of the depth detail level adjustments of computer-aided diagnosis tools. If the treating physician decides to store result data of an image post-processing process in a report file (in which finding data are typically stored together with CT or, MRT examination exposures, examination parameters, and the basic data of a patient) in order to ensure the reproducibility of these examinations, the associated VRT parameter values are transparently stored in the report file and ultimately are transmitted to the server 102. If the report file is reloaded into the client 104 at a later point in time, the inventive image retrieval system is capable of retrieving the associated depth detail level adjustments for the computer-aided diagnosis tools, which enable it to continue the examination at the point in time at which the stored results were acquired. If, for example, the treating physician stores image data of an image generated by means of a volume rendering technique as a part of the report file, the image retrieval system stores the depth detail level adjustments and the image data of an image region of interest for the respective image data set together with the VRT parameter values for the image preparation module. These can be, for example, the function rule of a projective mapping for projection of three-dimensional image data of a real or virtual subject 604 to be presented on the two-dimensional image plane of a client screen, parameter values for description of the camera perspective and/or the exposure of the shown subject scenario, etc. If the report file is reloaded into the client workstation at a later point in time and the user clicks on the image generated in a volume rendering technique, for example by actuation of a function key of a computer mouse connected to the client workstation, the image retrieval system retrieves the appertaining volume data from the server 102 with the depth detail level last shown before the storage of the report file and, with the aid of the predetermined parameter values, generates a perspective 3D representation of the volume data by means of a volume rendering technique, such that the user can continue the examination at the last implemented state, for example in the state at the point in time at which the report file was stored.

In comparison to conventional PACS systems according to the prior art, the automatic depth detail level adjustment of the client/server-based image retrieval method described in the preceding according to the present invention achieves some significant advantages:

Since only a single data set of high-resolution volume data per patient examination is stored at the server, image data of full resolution are accessible at any time to all treating physicians connected to the image archiving, image retrieval and image rendering system. An unnecessarily redundant storage of image reconstructions of different resolution at the client 104 is avoided in this manner. Moreover, the transparent integration of full-resolution image data in the clinical workflow avoids burdensome interruptions of the diagnosis process that can occur in conventional PACS systems based on a processing of 2D slice images. In contrast to this, in the inventive client/server-based image archiving, image retrieval and image rendering system, the treating physician perceives image data of a patient examination in the form of a 2D, 3D or (with additional consideration of the time dependency) 4D image of “unlimited resolution” which can be examined transparently.

Conventional PACS systems based on a processing of slice images transmit full-resolution image data of implemented patient examinations via a data transfer network. This approach generates extremely high data traffic with resulting increased response times for the case that a plurality of users is connected with the PACS server. In comparison, in the inventive client/server-based image archiving, image retrieval and image rendering system, the system response times and the data traffic directed over the data transfer network are kept at low values by intelligent compression and data stream transfer schemes that take into account the different depth detail levels of volume data to be presented. In this manner, physicians working at the screen client 104 receive the images to be generated for a two-dimensional presentation of prepared three-dimensional or four-dimensional image data without noticeable delays, regardless of the data quantity of the image data to be presented in graphical form.

Presently available PACS systems can make the clinical workflow more difficult due to interruptions of the examination procedure, such that the treating physicians are compelled to repeat image post-processing steps that have already been executed at the appertaining client workstation 104 or to implement new image reconstructions with high resolution at the imaging apparatus. The inventive client/server-based image archiving, image retrieval and image rendering system integrates image post-processing functionalities on the part of the PACS workstation 104, which enables the treating physicians to operate computer-aided diagnosis tools without leaving their workstation. A source of interference for the clinical workflow is avoided in this manner.

Since the image post-processing functionalities in the inventive client/server-based image archiving, image retrieval and image rendering system are divided between the clients 104 and the server 102, the hardware requirements for the clients 104 are sufficiently within the capacity range of home PCs to enable the use of the full capabilities of the image retrieval system at many sites without incurring additional costs. Moreover, the capability to interact with computer-aided diagnosis tools from the respective sites of different multiple PACS workstations 104 enables the full integration of these software tools into the clinical workflow.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for retrieval and graphical visualization of multi-dimensional compressed image data on a screen client of an image archiving/retrieval and rendering system operating on a client/server basis, said method comprising the steps of:
requesting compressed volume data of a subject from a server by a screen client of the server for image rendering at the screen client, and transferring the requested compressed volume data from the server to the screen client and presenting the subject at the screen client in graphical form in a virtual subject space; and
said screen client having a screen plane, and at said screen client, automatically partitioning said virtual subject space into a plurality of volume units of respectively different sizes, dependent on a depth distance of volume regions, to be presented by said volume units, from an observation point situated in front of said screen plane, said screen client decreasing the respective sizes of said volume units in a predetermined manner toward a direction of said observation point and loading compressed image data of lower resolution of a volume data set of the volume regions partitioned most coarsely and farthest from said observation point and successively downloading compressed image data of higher resolution, being less compressed in said direction of decreasing depth distance, for volume units of volume regions partitioned more finely in the direction of said observation point, and presenting volume regions with increasing proximity to said observation point at a higher, spatially variable depth detail level than volume units of said more coarsely partitioned volume regions farther from said observer.

2. A method as claimed in claim 1 comprising, at said screen client, spatially varying said depth detail level of the volumetric image data presented at the screen client dependent on the subject or a region of the subject.

3. A method as claimed in claim 2 comprising, at said screen client, spatially varying said depth detail level dependent on a perspective depth distance of the subject or the region of the subject from said observation point.

4. A method as claimed in claim 2 comprising, at said screen client, spatially varying said depth detail level by increasing said depth detail level according to a user-defined degree in an image section enlargement procedure initiated by a user interacting with the screen client to select a larger presentation scale.

5. A method as claimed in claim 1 comprising storing said volume data to be presented at said screen client with a finest possible resolution predetermined by said system in a databank of said system, and administering said databank by said server and restricting access to said databank to allow said databank to be directly accessible only by said server.

6. A method as claimed in claim 1 comprising executing algorithms having a high computational requirement exclusively at said server, selected, from the group consisting of complex filtering, image segmentation, clustering, image rendering, feature extraction and pattern recognition, and executing algorithms on said compressed volume data exclusively at said screen client having a computational requirement that is lower than said high computational requirement.

7. A method as claimed in claim 1 wherein said client server partitions said virtual subject space into said volume units using a tree-like hierarchical data structure that allows only volume data to be retrieved that correspond to image regions that are currently in use by a user interacting with the screen client.

8. A method as claimed in claim 1 comprising, at said server, generating said compressed volume data using a compression algorithm that encodes at least one of shapes, surface textures and subject structures of the subject to the presented.

9. A method as claimed in claim 8 comprising, at said server, generating said compressed volume data requested by the screen client using wavelet compression.

10. A method as claimed in claim 1 comprising, from said screen client, requesting compressed volume data as time independent or time-dependent data associated with at least one of image rendering of two-dimensional raster graphics and image rendering of three-dimensional raster graphics.

11. A method as claimed in claim 1 comprising, at said screen client, generating a rendered image from the requested compressed volume data using a function value for said depth detail level that is at least one of a spatially variable function value, a region-specific function value, and a subject-specific function value, and, for each rendered image, storing all function values that were used to generate the rendered image.

12. A method as claimed in claim 1 comprising employing a PACS system for archiving and transferring medical volume data as said image archiving, retrieval and rendering system.

13. A method for visualization of multi-dimensional compressed image data, representing a subject in graphical form in a virtual subject space on a screen having a screen plane, comprising the steps of:
in a computer, automatically partitioning said virtual subject space into a plurality of volume units of respectively different sizes, dependent on a depth distance of volume regions, to be presented by said volume units, from an observation point situated in front of said screen plane, and decreasing the respective sizes of said volume units in a predetermined manner toward a direction of said observation point and loading compressed image data of lower resolution of a volume data set of the volume regions partitioned most coarsely and farthest from said observation point and successively downloading compressed image data of higher resolution to said computer, the downloaded data being less compressed in said direction of decreasing depth distance, for volume units of volume regions partitioned more finely in the direction of said observation point; and
presenting volume regions at said screen with increasing proximity to said observation point at a higher, spatially variable depth detail level than volume units of said more coarsely partitioned volume regions farther from said observer.

14. A method as claimed in claim 13 comprising partitioning said virtual subject space into said volume units using a tree-like hierarchical data structure.

15. A screen client for retrieval and graphical visualization of multi-dimensional compressed image data in an image archiving/retrieval and rendering system operating on a client/server basis, comprising:
an interface to a server, of which said screen client is a client, from which said screen client requests compressed volume data of a subject from the server for image rendering at the screen client, for presentation of a subject, represented by the compressed data, at the screen client in graphical form in a virtual subject space; and
said screen client having a screen plane, and said screen client automatically partitioning said virtual subject space into a plurality of volume units of respectively different sizes, dependent on a depth distance of volume regions, to be presented by said volume units, from an observation point situated in front of said screen plane, said screen client decreasing the respective sizes of said volume units in a predetermined manner toward a direction of said observation point and loading compressed image data of lower resolution of a volume data set of the volume regions partitioned most coarsely and farthest from said observation point and successively downloading compressed image data of higher resolution, being less compressed in said direction of decreasing depth distance, for volume units of volume regions partitioned more finely in the direction of said observation point, and presenting volume regions with increasing proximity to said observation point at a higher, spatially variable depth detail level than volume units of said more coarsely partitioned volume regions farther from said observer.

16. A screen client as claimed in claim 15 comprising, at said screen client, spatially varying said depth detail level of the volumetric image data presented at the screen client dependent on the subject or a region of the subject.

17. A client/server-based image archiving, retrieval and rendering system for retrieval and graphical visualization of multi-dimensional compressed image data on a screen client of an image archiving/retrieval and rendering system operating on a client/server basis, comprising:
a server at which compressed volume data representing a subject are available on request;
a screen client of said server that requests said compressed volume data from the server for image rendering at the screen client and presentation of the subject at the screen client in graphical form in a virtual subject space;
a network placing said server and said screen client in communication with each other, that supplies the request for said compressed volume data from the client screen to the server, and that transfers the requested compressed volume data from the server to the client screen; and
said screen client having a screen plane, and said screen client automatically partitioning said virtual subject space into a plurality of volume units of respectively different sizes, dependent on a depth distance of volume regions, to be presented by said volume units, from an observation point situated in front of said screen plane, said screen client decreasing the respective sizes of said volume units in a predetermined manner toward a direction of said observation point and loading compressed image data of lower resolution of a volume data set of the volume regions partitioned most coarsely and farthest from said observation point and successively downloading compressed image data of higher resolution, being less compressed in said direction of decreasing depth distance, for volume units of volume regions partitioned more finely in the direction of said observation point, and presenting volume regions with increasing proximity to said observation point at a higher, spatially variable depth detail level than volume units of said more coarsely partitioned volume regions farther from said observer.

18. A system as claimed in claim 17 wherein said screen client spatially varies said depth detail level of the volumetric image data presented at the screen client dependent on the subject or a region of the subject.

19. A system as claimed in claim 18 wherein said screen client, spatially varies said depth detail level dependent on a perspective depth distance of the subject or the region of the subject from said observation point.

20. A system as claimed in claim 17 comprising a memory wherein said volume data to be presented at said screen client are stored with a finest possible resolution predetermined by said system and said server administering said memory and restricting access to said memory to allow said memory to be directly accessible only by said server.

21. A system as claimed in claim 17 wherein said image archiving, retrieval and rendering are executed in a PACS architecture.

22. A computer-readable medium encoded with a data structure, said computer readable medium being loadable into a server and a screen client, that is a client of said server, in a client/server-based image archiving, retrieval and image rendering system, said screen client having a screen plane and said data structure causing said server and said client screen to:
from the screen client, request compressed volume data of a subject from the server for image rendering at the screen client, and from the server, transfer the requested compressed volume data to the screen client for presentation of the subject at the screen client in graphical form in a virtual subject space; and
at said screen client, automatically partition said virtual subject space into a plurality of volume units of respectively different sizes, dependent on a depth distance of volume regions, to be presented by said volume units, from an observation point situated in front of said screen plane, said screen client decreasing the respective sizes of said volume units in a predetermined manner toward a direction of said observation point and load compressed image data of lower resolution of a volume data set of the volume regions partitioned most coarsely and farthest from said observation point and successively download compressed image data of higher resolution, being less compressed in said direction of decreasing depth distance, for volume units of volume regions partitioned more finely in the direction of said observation point, and present volume regions with increasing proximity to said observation point at a higher, spatially variable depth detail level than volume units of said more coarsely partitioned volume regions farther from said observer.
